(19) United States
(12) Patent Application Publication
(10) Pub. No.: US 2004/0267684 A1
(43) Pub. Date: Dec. 30, 2004

(54) Method and system for determining a current first state of a first temporal sequence of respective first states of a dynamically modifiable system

(76) Inventors: Caglayan Erdem, Augsburg (DE); Hans-Georg Zimmermann, Percha (DE)

Correspondence Address: STAAS & HALSEY LLP, SUITE 700, 1201 NEW YORK AVENUE, N.W., WASHINGTON, DC, 20005, US

(21) Appl. No.: 10/490,042

(22) PCT Filed: Sep. 17, 2002
(86) PCT No.: PCT/DE02/03494

(30) Foreign Application Priority Data
Sep. 19, 2001 (DE) 101 46 222.0

(51) Int. Cl. G06N 7/00; G06N 7/08; G06F 17/00

(52) U.S. Cl. 706/58

(57) ABSTRACT

A current first state, of a first temporal sequence of respective first states of a dynamically modifiable system, is determined. The first current state of the system is determined by combining a first system-inherent information flow comprising past system information of the system with a second system-inherent information flow comprising future system information in the first current state. The first current state is then determined from the combination.

### CROSS REFERENCE TO RELATED APPLICATIONS

This application is based on and hereby claims priority to PCT Application No. PCT/DE02/03494 filed on Sep. 17, 2002 and German Application No. 101 46 222.0 filed on Sep. 19, 2001, the contents of which are hereby incorporated by reference.

### BACKGROUND OF THE INVENTION

The invention relates to determining a current first state of a first temporal sequence of respective first states of a dynamically modifiable system.

It is known from S. Hayken, Neural Networks: A Comprehensive Foundation, McMillan College Publishing Company, Second Edition, ISBN 0-13-273350-1, pp. 732-789, 1999 (“the Hayken reference”) how to employ an arrangement for imaging temporally modifiable state descriptions to describe a dynamic system. The arrangement is implemented by interconnected computing elements used to effect the imaging.

A dynamic system or, as the case may be, dynamic process is in general customarily described by a state transition description which is not visible to an observer of the dynamic process and by an output equation describing observable variables of the technical dynamic process.

A relevant structure of a dynamic system of this type is shown in FIG. 2a.

The dynamic system 200 is subject to the influence of an external input variable u of pre-definable dimension, with an input variable uₜ at a time t being designated uₜ:

uₜ

[symbol]

where 1 designates a natural number.

The input variable uₜ at a time t causes a modification to the dynamic process running in the dynamic system 200.

An internal state sₜ (sₜ [symbol] ) of pre-definable dimension m at a time t is unobservable for an observer of the dynamic system 200.

A state transition of the internal state sₜ of the dynamic process is caused as a function of the internal state sₜ and of the input variable uₜ, and the state of the dynamic process changes to a follow-on state sₜ₊₁ at a following time t+1.

The following applies here:

sₜ₊₁=f(sₜ,uₜ), (1)

where f(.) designates a general imaging rule.

An output variable yₜ at a time t observable by an observer of the dynamic system 200 depends on the input variable uₜ and on the internal state sₜ.

The output variable yₜ (yₜ z,3 ) is of a pre-definable dimension n.

The dependency of output variable yₜ on the input variable uₜ and on the internal state sₜ of the dynamic process is determined by the following general rule:

yₜ=g(sₜ,uₜ), (2)

where g(.) designates a general imaging rule.

A system of interconnected computing elements in the form of a neural network of interconnected neurons is employed in the Hayken reference to describe the dynamic system 200. The connections between the neurons of the neural network are weighted. The weights of the neural network are combined in a parameter vector v.

Thus an internal state of a dynamic system which is subject to a dynamic process depends, according to the following rule, on the input variable uₜ and the internal state of the preceding time sₜ, and on the parameter vector v:

sₜ₊₁=NN(v,sₜ,uₜ), (3)

where NN(.) designates an imaging rule determined by the neural network.

The arrangement known from the Hayken reference and referred to as a Time Delay Recurrent Neural Network (TDRNN) is trained in a training phase in such a way that a target variable y_{d}^{t} is in each case determined on a real dynamic system for an input variable uₜ. The tuple (input variable, determined target variable) is referred to as a training datum. A plurality of such training data form a training data record.

Temporally succeeding tuples (uₜ₋₄, yₜ₋₄^{d}), (uₜ₋₃, yₜ₋₃^{d}), (uₜ₋₂, yₜ₋₂^{d}) of times (t−4, t−3, t−3, . . . ) of the training data record in each case have a pre-defined time step.

The TDRNN is trained by the training data record. An overview of various training methods can also be found in the Hayken reference.

It must be emphasized at this point that it is only possible to discern the output variable yₜ at a time t of the dynamic system 200: the “internal” system state sₜ is unobservable.

The following cost function E is customarily minimized in the training phase:

$$E = \frac{1}{T} {\sum }_{t = 1}^{T} {( {y}_{t} - {y}_{t}^{d} )}^{2} -> {min}_{f , g} , \qquad ( 4 )$$

Where T designates the number of times taken into consideration.

An overview of fundamentals of neural networks and the possible applications of neural networks in the area of the economy is furthermore given in H. Rehkugler and H. G. Zimmermann, Neuronale Netze in der Ökonomie, Grundlagen und finanzwirtschaftliche Anwendungen, published by Franz Vahlen, Munich, ISBN 3-8006-1871-0, pp. 3-90, 1994 (“the Rehkugler et al. reference”).

The known arrangements and methods particularly have the disadvantage that a dynamic system or, as the case may be, process requiring to be described can only be described by them with insufficient accuracy. This is because the imaging employed in the case of the arrangements and methods is only able to simulate the state transition description of the dynamic process with insufficient accuracy.

### SUMMARY OF THE INVENTION

One possible object underlying the invention is accordingly to disclose a method and an arrangement for the computer-assisted imaging of temporally modifiable state descriptions enabling a state transition description of a dynamic system to be described with improved accuracy, with the disclosed arrangement and method not exhibiting the disadvantages of the known arrangements and methods. Theby

In the method for determining a current first state of a first temporal sequence of respective first states of a dynamically modifiable system the following procedural steps are carried out in a first state space:

a second temporal sequence of respective second states of the system is determined in a second state space, the second temporal sequence having at least one current second state and one older second state temporally preceding the current second state,

a third temporal sequence of respective third states of the system is determined in the second state space, the third temporal sequence having at least one future third state and one younger third state temporally succeeding the future third state,

the current first state is determined by a first transformation of the current second state from the second state space to the first state space and of a second transformation of the future third state from the second state space to the future state space.

The arrangement for determining a current first state of a first temporal sequence of respective first states of a dynamically modifiable system in a first state space has interlinked computing elements, with the computing elements in each case representing a state of the system and with the links in each case representing a transformation between two states of the system, wherein

first computing elements are set up in such a way that it is possible to determine a second temporal sequence of respective second states of the system in a second state space, the second temporal sequence having at least one current second state and one older second state temporally preceding the current second state,

second computing elements are set up in such a way that it is possible to determine a third temporal sequence of respective third states of the system in the second state space, the third temporal sequence having at least one future third state and one younger third state temporally succeeding the future third state,

a third computing element is set up in such a way that it is possible to determine the current first state by a first transformation of the current second state from the second state space to the first state space and of a second transformation of the future third state from the second state space to the future state space.

The system is especially suitable for carrying out the methods or one of their developments explained below.

Viewed in clear terms, the first current state of the system is determined by combining a first system-inherent information flow comprising past system information of the system with a second system-inherent information flow comprising future system information in the first current state and then determining the first current state from the combination.

The further developments described below relate both to the methods and to the arrangement.

The method and apparatus described below can be implemented both in software and in hardware form, for example using special electrical circuitry.

The method and apparatusdescribed below, can also be implemented by a computer-readable storage medium on which is stored a computer program which carries out the described method.

The method and apparatus, or a development thereof described below, can also be implemented by a computer program product having a storage medium on which is stored a computer program which carries out the described method.

The inventors propose that two, temporally succeeding second states of the second temporal sequence are in each case coupled to each other by a third transformation.

This coupling by the third transformation can be embodied in such a way that a temporally younger second state is determined from a temporally older second state.

In an embodiment, two temporally succeeding third states of the third sequence can furthermore in each case be coupled to each other by a fourth transformation.

This coupling by the fourth transformation can be embodied in such a way that a temporally older third state is determined from a temporally younger third state.

The inventors propose that a younger second state of the second temporal sequence temporally succeeding the current second state is determined

by the third transformation of the current second state and

by a fifth transformation of the current state from the first state space to the second state space.

It is also possible to determine a current third state of the third temporal sequence temporally preceding the future third state

by the fourth transformation of the future third state, and

by a sixth transformation of the current state from the first state space to the second state space.

The accuracy of the description of a state transition description of a dynamic system can be improved by determining any error there may be between the determined first current state and a pre-specified current first state. Error determining of this type is referred to as “error correction”.

The description of a state transition description can be improved if external state information of the system is in each case added to the second states of the second temporal sequence and/or to the third states of the third temporal sequence.

Moreover, a state of the system can be described by a vector of pre-definable dimension.

The method may be used in order to determine a dynamic characteristic of the dynamically modifiable system, with the first temporal sequence of the respective first states describing the dynamic characteristic.

An instance of a dynamic characteristic of this type is that of an electrocardiogram, with the respective first temporal sequence of the respective first states being signals of an electrocardiogram.

The dynamic characteristic can also be that of an economic system, with the first temporal sequence of the respective first states in this case being economic, macroeconomic, or microeconomic states described by a corresponding economic variable.

The method may make it possible to determine the dynamic characteristic of a chemical reactor, with the first temporal sequence of the respective first states being described by chemical state variables of the chemical reactor.

A further embodiment is used in order to predict a state of the dynamically modifiable system with, in this case, the determined first current state being used as the predicted state.

A development provides for fourth computing elements which are in each case linked to a first computing element and/or to a second computing element and which are set up in such a way as to enable a fourth state of a fourth temporal sequence of respective fourth states of the system to be routed to, in each case, one of the fourth computing elements, with each fourth state containing external state information of the system.

A further embodiment furthermore provides for embodying at least one part of the computing elements as artificial neurons and/or at least one part of the links between the computing elements on a variable basis.

It is further possible to provide a measuring system for recording physical signals with which states of the dynamically modifiable system are described.

Developments can also be used for processing speech.

In a development of this type it is possible, for example, for

the external state information to be a first item of speech information of a word and/or syllable and/or phoneme being spoken, and for

the current first state to comprise a second item of speech information of the word and/or syllable and/or phoneme being spoken.

It can also be a provision of a development of this type for

the first item of speech information to include a classification of the word and/or syllable and/or phoneme being spoken and/or an item of pause information about the word and/or syllable and/or phoneme being spoken, and/or

for the second item of speech information to include an item of articulation information about the word and/or syllable and/or phoneme being spoken and/or an item of sound length information about the word and/or syllable and/or phoneme being spoken.

It is further possible in a development of this type for

the first item of speech information to include an item of phonetic and/or structural information about the word and/or syllable and/or phoneme being spoken, and/or

for the second item of speech information to include an item of frequency information about the word and/or syllable and/or phoneme being spoken and/or a duration of sound length of the word and/or syllable and/or phoneme being spoken.

### BRIEF DESCRIPTION OF THE DRAWINGS

These and other objects and advantages of the present invention will become more apparent and more readily appreciated from the following description of the preferred embodiments, taken in conjunction with the accompanying drawings of which:.

FIG. 1 is a sketch of an arrangement according to a first exemplary embodiment (KRKNN);

FIGS. 2a and 2b are a first sketch of a general description of a dynamic system and a second sketch of a description of a dynamic system which is based on a “causal retro-causal” relationship;

FIG. 3 shows an arrangement according to a second exemplary embodiment (KRKFKNN);

FIG. 4 is a sketch of a chemical reactor by which variables are measured which are further processed using the arrangement according to the first exemplary embodiment;

FIG. 5 is a sketch of an arrangement of a TDRNN, the arrangement being developed over time with a finite number of states;

FIG. 6 is a sketch of a traffic control system modeled using the arrangement within the framework of a second exemplary embodiment;

FIG. 7 is a sketch of an alternative arrangement according to a first exemplary embodiment (KRKNN with released connections);

FIG. 8 is a sketch of an alternative arrangement according to a second exemplary embodiment (KRKFKNN with released connections);

FIG. 9 is a sketch of an alternative arrangement according to a first exemplary embodiment (KRKNN);

FIG. 10 is a sketch of a speech processing process using an arrangement according to a first exemplary embodiment (KRKNN);

FIG. 11 is a sketch of a speech processing process using an arrangement according to a second exemplary embodiment (KRKFKNN).

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

First Exemplary embodiment: Chemical reactor

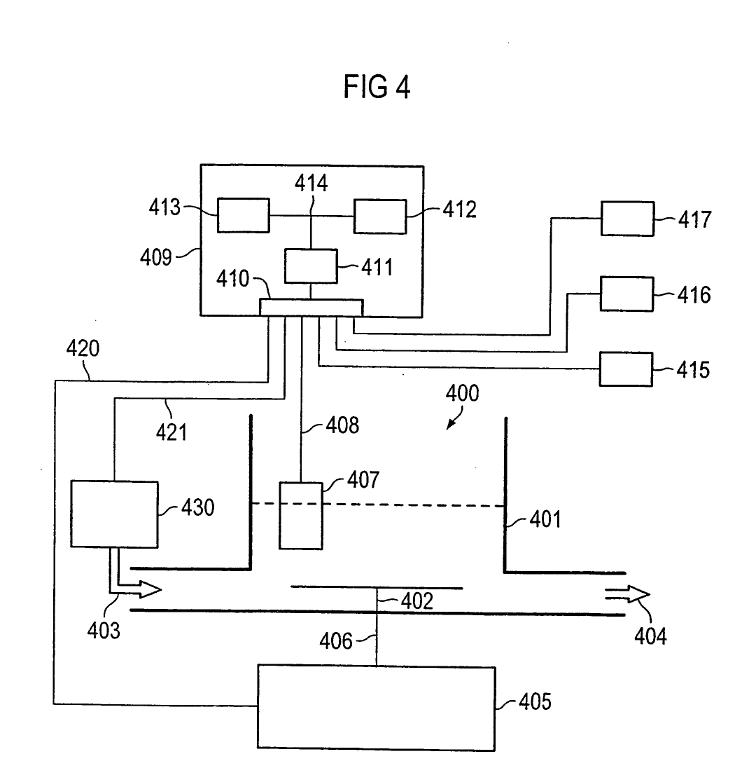

FIG. 4 shows a chemical reactor 400 filled with a chemical substance 401. Chemical reactor 400 includes a mixer 402 by which chemical substance 401 is mixed. Other chemical substances 403 flowing into chemical reactor 400 react during a pre-definable period of time in chemical reactor 400 with chemical substance 401 already contained in chemical reactor 400. A substance 404 flowing out of chemical reactor 400 is let off from chemical reactor 400 via an output.

Mixer 402 is connected via a lead to a control unit 405 by which a mixing frequency of mixer 402 can be set via a control signal 406.

Provision is furthermore made for a measuring device 407 by which concentrations of chemical substances contained in chemical substance 401 are measured.

Measuring signals 408 are routed to a computer 409, digitized in the computer via an input/output interface 410 and an analog/digital converter 411, and stored in a memory 412. A processor 413 is connected, as is memory 412, to analog/ digital converter 411 via a bus 414. Computer 409 is furthermore connected via input/output interface 410 to control unit 405 of mixer 402, and computer 409 thus controls the mixing frequency of mixer 402.

Computer 409 is furthermore connected via input/output interface 410 to a keyboard 415, a computer mouse 416, and a monitor screen 417.

Chemical reactor 400 is thus subject as a dynamic technical system 250 to a dynamic process.

Chemical reactor 400 is described by a state description. An input variable uₜ of the state description in this case comprises details of the temperature prevailing in chemical reactor 400, the pressure prevailing in chemical reactor 400, and the mixing frequency set at time t. Input variable uₜ is thus a three-dimensional vector.

The aim of modeling, described below, of chemical reactor 400 is to determine the dynamic development of substance concentrations in order to enable efficient production of a pre-definable target substance flowing out as substance 404.

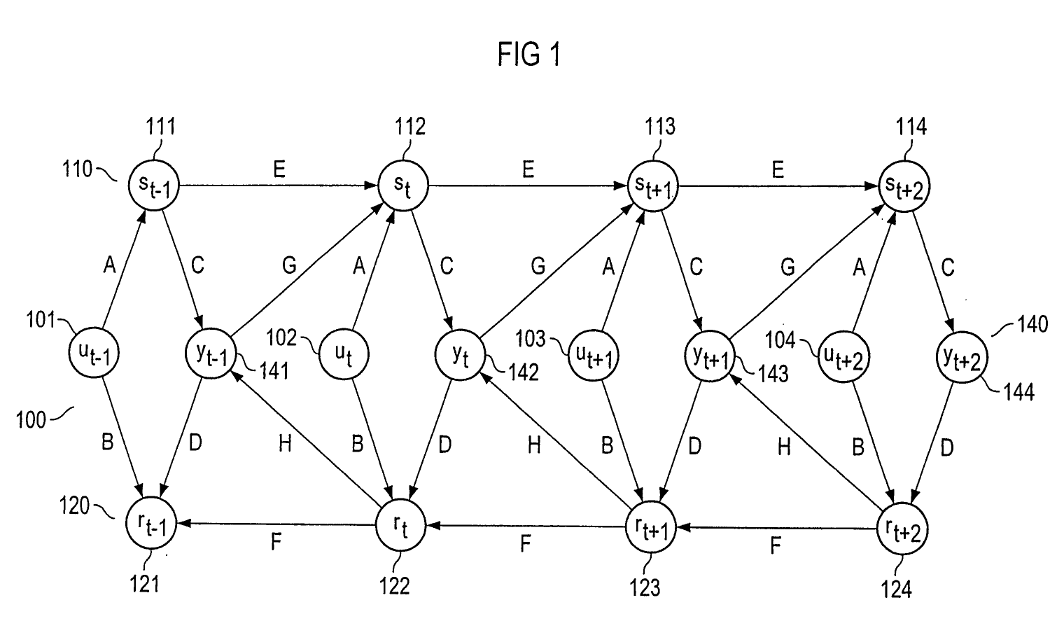

This is done using the arrangement which is described below and shown in FIG. 1.

The dynamic process underlying the described reactor 400 and having what is termed a “causal retro-causal” relationship is described by a state transition description which is not visible to an observer of the dynamic process and by an output equation describing observable variables of the technical dynamic process.

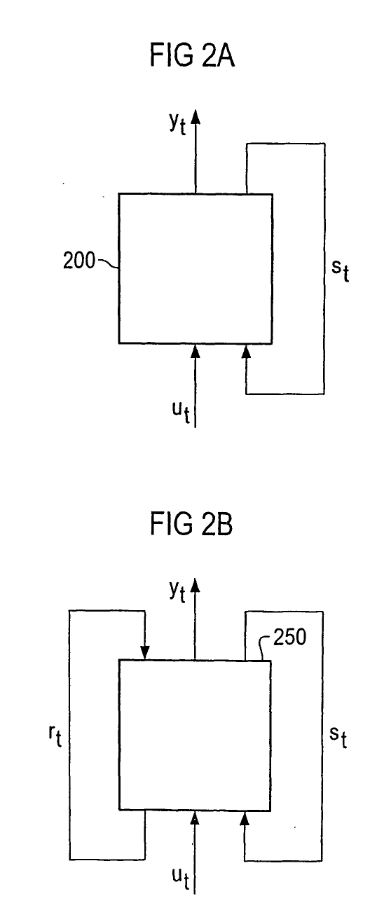

A structure of the type of a dynamic system having a “causal retro-causal” relationship is shown in FIG. 2b.

Dynamic system 250 is subject to the influence of an external input variable u of pre-definable dimension, with an input variable uₜ at a time t being designated uₜ:

uₜ

[symbol]

where 1 designates a natural number.

The input variable uₜ at a time t causes a modification to the dynamic process running in the dynamic system 250.

An internal state of system 250 at a time t, which is a state that is unobservable for an observer of system 250, in this case comprises a first internal partial state sₜ and a second internal partial state rₜ.

A state transition of the first internal partial state sₜ₋₁ of the dynamic process to a follow-on state sₜ is caused as a function of the first internal partial state sₜ₋₁ at an earlier time t−1 and of the input variable uₜ.

The following applies here:

sₜ=f1(sₜ₋₁,uₜ), (5)

where f1(.) designates a general imaging rule.

Viewed in clear terms, the first internal partial state sₜ is influenced by an earlier first internal partial state sₜ₋₁ and by input variable uₜ. A relationship of this type is usually referred to as “causality”.

A state transition of the first internal state rₜ₊₁ of the dynamic process to a follow-on state rₜ is caused as a function of the second internal partial state rₜ₊₁ at a succeeding time t+1 and of input variable uₜ.

The following applies here:

rₜ=f2(rₜ₊₁,uₜ), (6)

where f2(.) designates a general imaging rule.

Viewed in clear terms, in this case the second internal partial state rₜ is influenced by a later second internal partial state rₜ₊₁, generally, therefore, by an expectation about a later state of dynamic system 250, and by input variable uₜ. A relationship of this type is referred to as “retro-causality”.

An output variable yₜ at a time t, which is a variable that is observable for an observer of dynamic system 250, therefore depends on the input variable uₜ, the first internal partial state sₜ, and the second internal partial state rₜ₊₁.

Output variable yₜ (yₜ [symbol] ) is of a pre-definable dimension n.

The dependency of output variable yₜ on input variable uₜ, the first internal partial state sₜ, and the second internal partial state rₜ₊₁ of the dynamic process is stated by the following general rule:

yₜ=g(sₜ,rₜ₊₁), (7)

where g(.) designates a general imaging rule.

An arrangement of interconnected computing elements in the form of a neural network of interconnected neurons is employed to describe dynamic system 250 and its states. The network is shown in FIG. 1 and is referred to as a “causal retro-causal” neural network (KRKNN).

The connections between the neurons of the neural network are weighted. The weights of the neural network are combined in a parameter vector v.

In the neural network, the first internal partial state sₜ and the second internal partial state rₜ depend, according to the following rules, on input variable uₜ, the first internal partial state sₜ₋₁, the second internal partial state rₜ₊₁, and parameter vectors vₛ, vₜ, v_{y}:

sₜ=NN(vₛ,sₜ₋₁,uₜ), (8)

rₜ=NN(vᵣ,rₜ₊₁,uₜ), (9)

yₜ=NN(v_{y},sₜ,rₜ), (10)

where NN(.) designates a general imaging rule specified by the neural network.

KRKNN 100 according to FIG. 1 is a neural network developed across four times t−1, t, t+1, and t+2.

Essential features of a neural network developed across a finite number of times are described in the Hayken reference.

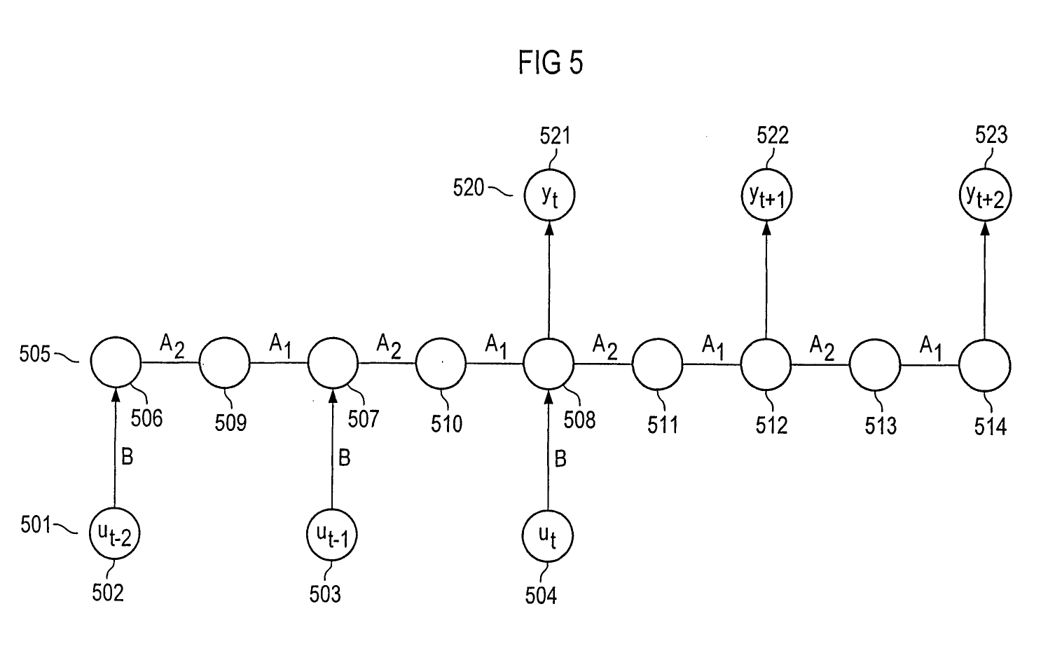

To make it easier to understand the principles underlying the KRKNN, FIG. 5 shows the known TDRNN as a neural network 500 developed across a finite number of times.

Neural network 500 shown in FIG. 5 has an input layer 501 with three partial input layers 502, 503, and 504 each containing a pre-definable number of input computing elements to which at a pre-definable time t input variables uₜ, which is to say temporal sequence values described below, can be applied.

Input computing elements, which is to say input neurons, are connected via variable connections to neurons of a pre-definable number of concealed layers 505.

Neurons of a first concealed layer 506 are herein connected to neurons of the first partial input layer 502. Neurons of a second concealed layer 507 are furthermore connected to neurons of the second input layer 503. Neurons of a third concealed layer 508 are connected to neurons of the third partial input layer 504.

The connections between the first partial input layer 502 and the first concealed layer 506, the second partial input layer 503 and the second concealed layer 507, and the third partial input layer 504 and the third concealed layer 508 are the same in each case. The weights of all connections are in each case contained in a first connection matrix B.

Neurons of a fourth concealed layer 509 are connected by their inputs to outputs of neurons of the first concealed layer 506 according to a structure provided by a second connection matrix A₂. Outputs of the neurons of the fourth concealed layer 509 are furthermore connected to inputs of neurons of the second concealed layer 507 according to a structure provided by a third connection matrix A₁.

Neurons of a fifth concealed layer 510 are furthermore connected by their inputs to outputs of neurons of the second concealed layer 507 according to a structure provided by the third connection matrix A₂. Outputs of the neurons of the fifth concealed layer 510 are connected to inputs of neurons of the third concealed layer 508 according to a structure provided by the third connection matrix A₁.

This type of connection structure applies in equivalent terms to inputs of a sixth concealed layer 511 which, according to a structure provided by the second connection matrix A₂, are connected to outputs of the neurons of the third concealed layer 508 and, according to a structure provided by the third connection matrix A1, are connected to neurons of a seventh concealed layer 512.

Neurons of an eighth concealed layer 513 are in turn connected according to a structure provided by the first connection matrix A₂ to neurons of the seventh concealed layer 512 and, via connections according to the third connection matrix A₁, to neurons of a ninth concealed layer 514. The information contained in the indices in the respective layers in each case indicates the time t, t−1, t−2, t+1, t+2 to which in each case the signals which can be tapped at or, as the case may be, routed to the outputs of the respective layer relate (uₜ, uₜ₋₁, uₜ₋₂).

An output layer 520 has three partial output layers, a first partial output layer 521, a second partial output layer 522, and a third partial output layer 523. Neurons of the first partial output layer 521 are connected according to a structure provided by an output connection matrix C to neurons of the third concealed layer 508. Neurons of the second partial output layer are likewise connected according to a structure provided by the output connection matrix C to neurons of the eighth concealed layer 512. Neurons of the third partial output layer 523 are connected according to output connection matrix C to neurons of the ninth concealed layer 514. The output variables for in each case a time t, t+1, t+2 (yₜ, Yₜ₊₁, yₜ₊₂) can be tapped at the neurons of partial output layers 521, 522, and 523.

Proceeding from this what is termed the ‘shared weights’ principle, which is to say the principle that equivalent connection matrices in a neural network have the same weights at a respective time, the arrangement shown in FIG. 1 will be explained below in the formed condition.

The sketches described below are each to be understood such that each layer or, as the case may be, each partial layer has a pre-definable number of neurons, which is to say computing elements.

Partial layers of a layer each represent a system state of the dynamic system described by the arrangement. Partial layers of a concealed layer accordingly each represent an “internal” system state.

The respective connection matrices are of any dimension and each contain the weight values applying to the relevant connections between the neurons of the respective layers.

The connections are directional and identified in FIG. 1 by arrows. An arrow direction indicates a “computing direction”, in particular an imaging direction or a transformation direction.

The arrangement shown in FIG. 1 has an input layer 100 with four partial input layers 101, 102, 103, and 104, with the possibility of routing in each case temporal sequence values uₜ₋₁, uₜ, uₜ₊₁, uₜ₊₂ at in each case a time t−1, t, t+1 or, as the case may be, t+2 to each the partial input layer 101, 102, 103, 104.

The partial input layers 101, 102, 103, 104 of input layer 100 are in each case connected via connections according to a first connection matrix A to neurons of a first concealed layer 110 with in each case four partial layers 111, 112, 113, and 114 of the first concealed layer 110.

The partial input layers 101, 102, 103, 104 of input layer 100 are additionally in each case connected via connections according to a second connection matrix B to neurons of a second concealed layer 120 with in each case four partial layers 121, 122, 123, and 124 of the second concealed layer 120.

The neurons of the first concealed layer 110 are in each case connected according to a structure provided by a third connection matrix C to neurons of an output layer 140, which in its turn has four partial output layers 141, 142, 143, and 144.

The neurons of the output layer 140 are in each case connected according to a structure provided by a fourth connection matrix D to the neurons of the second concealed layer 120.

The neurons of output layer 140 are also in each case connected according to a structure provided by an eighth connection matrix G to the neurons of the first concealed layer 110.

The neurons of the second concealed layer 120 are furthermore in each case connected according to a structure provided by a seventh connection matrix H to the neurons of the output layer 140.

Moreover, partial layer 111 of the first concealed layer 110 is connected via a connection according to a fifth connection matrix E to the neurons of partial layer 112 of the first concealed layer 110.

All other partial layers 112, 113, and 114 of the first concealed layer 110 also have corresponding connections.

Viewed in clear terms, this means all partial layers 111, 112, 113, and 114 of the first concealed partial layer 110 are interconnected according to their temporal sequence t−1, t, t+1, and t+2.

Partial layers 121, 122, 123, and 124 of the second concealed layer 120 are at this particular time interconnected in opposite directions.

In this case, partial layer 124 of the second concealed layer 120 is connected via a connection according to a sixth connection matrix F to the neurons of partial layer 123 of the second concealed layer 120.

All other partial layers 123, 122, and 121 of the second concealed layer 120 also have corresponding connections.

Viewed in clear terms, all partial layers 121, 122, 123, and 124 of the second concealed partial layer 120 are in this case interconnected counter to their temporal sequence, therefore t+2, t+1, t, and t−1.

According to the connections described, an “internal” system state sₜ, sₜ₊₁ or, as the case may be, Sₜ₊₂ of partial layer 112, 113 or, as the case may be, 114 of the first concealed layer is formed in each case from the associated input state uₜ, uₜ₊₁ or, as the case may be, uₜ₊₂, from the temporally preceding output state yₜ₋₁, yₜ or, as the case may be, yₜ, and from the temporally preceding “internal” system state sₜ₋₁, sₜ or, as the case may be, sₜ.

Furthermore, according to the connections described, an “internal” system state rₜ₋₁, rₜ or, as the case may be, rₜ₊₁ of partial layer 121, 122 or, as the case may be, 123 of the second concealed layer 120 is formed in each case from the associated output state yₜ₋₁, yₜ or, as the case may be, yₜ₊₁, from the associated input state uₜ₋₁, uₜ or, as the case may be, uₜ₊₁, and from the temporally succeeding “internal” system state rₜ, rₜ₊₁ or, as the case may be, rₜ₊₂.

In partial output layers 141, 142, 143, and 144 of output layer 140 a state is in each case formed from the associated “internal” system state sₜ₋₁, sₜ, sₜ₊₁ or, as the case may be, Sₜ₊₂ of a partial layer 111, 112, 113 or, as the case may be, 114 of the first concealed layer 110, and from the temporally preceding “internal” system state rₜ, rₜ₊₁, rₜ₊₂ or, as the case may be, rₜ₊₃ (not shown) of a partial layer 122, 123 or, as the case may be, 124 of the second concealed layer 120.

At an output of first partial output layer 141 of output layer 140 it is therefore possible to tap a signal which is dependent on the “internal” system states (sₜ,rₜ).

The same applies analogously to partial output layers 142, 143, and 144.

The following cost function E is minimized during the training phase of the KRKNN:

$$E = \frac{1}{T} {\sum }_{t = 1}^{T} {( {y}_{t} - {y}_{t}^{d} )}^{2} -> {min}_{f , g} , \qquad ( 11 )$$

Where T designates the number of times taken into consideration.

A back-propagation method is employed as the training method. The training data record is obtained in the following manner from chemical reactor 400.

Concentrations at defined input variables are measured with measuring device 407 and routed to computer 409, where they are digitized and grouped in a memory into temporal sequence values xₜ together with the relevant input variables corresponding to the measured variables.

The weight values of the respective connection matrices are matched during training. In clear terms, matching takes place in such a way that the KRKNN describes the dynamic system simulated by it, in this case the chemical reactor, as accurately as possible.

The arrangement from FIG. 1 is trained using the training data record and the cost function E.

The arrangement from FIG. 1 trained according to the above described training method is used to control and monitor chemical reactor 400. For this, a predicated output variable yₜ₊₁ is determined from input variables uₜ₋₁, uₜ. The output variable is then routed as a control variable, where applicable after any editing that may be required, to control unit 405 for controlling mixer 402 and to control equipment 430 for controlling the feed flow (see also FIG. 4).

Second exemplary embodiment: Predicting a rental price

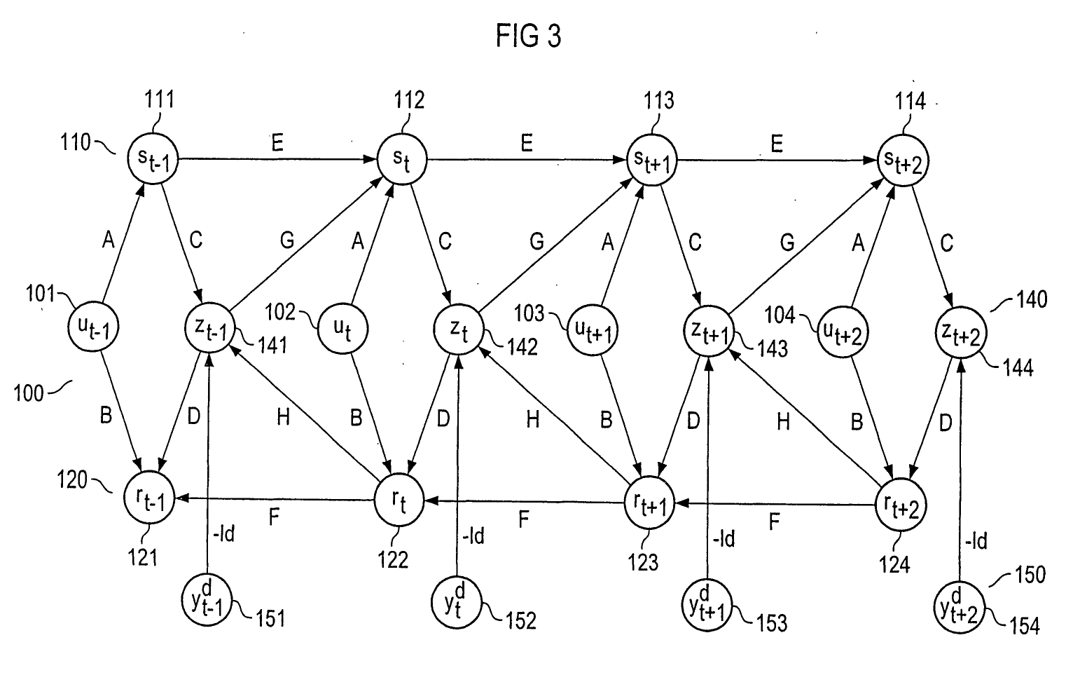

FIG. 3 shows a development of the KRKNN which is shown in FIG. 1 and described within the framework of the above embodiments.

The developed KRKNN shown in FIG. 3, what is termed a causal retro-causal error-correcting neural network (KRKFKNN), is used for predicting a rental price.

The input variable uₜ in this case comprises details of a rental price, an offer of accommodation space, an inflation figure, and an unemployment rate, the details which relate to a residential area under examination being determined in each case at the end of the calendar year (December values). The input variable is thus a four-dimensional vector. A temporal sequence of the input variables including a plurality of temporally succeeding vectors has time steps of in each case one year.

The aim of modeling the establishment of a rental price, as described below, is to predict a future rental price.

The arrangement described below and shown in FIG. 3 is used to provide a description of the dynamic process of establishing a rental price.

Components from FIG. 1 are given the same reference numerals where the embodiment is the same.

The KRKFKNN additionally has a second input layer 150 with four partial input layers 151, 152, 153, and 154, with the possibility of routing in each case temporal sequence values yₜ₋₁^{d}, yₜ^{d}, yₜ₊₁^{d}, yₜ₊₂^{d} at in each case a time t−1, t, t+1 or, as the case may be, t+2 to each the partial input layer 151, 152, 153, 154. The temporal sequence values yₜ₋₁^{d}, yₜ^{d}, yₜ₊₁^{d}, yₜ₊₂^{d} are herein output values measured on the dynamic system.

Partial input layers 151, 152, 153, 154 of input layer 150 are in each case connected via connections according to a ninth connection matrix, which is a negative identity matrix, to neurons of output layer 140.

A differential state (yₜ₋₁-yₜ₋₁^{d}), (yₜ-yₜ^{d}), (yₜ₊₁-yₜ₊₁^{d}), and (yₜ₊₂-yₜ₊₂^{d}) is thus formed in each case in partial output layers 141, 142, 143, and 144 of the output layer.

The procedure for training the above described arrangement corresponds to that for training the arrangement according to the first exemplary embodiment.

Third exemplary embodiment: Traffic modeling and tailback predicting

A third exemplary embodiment described below describes an instance of traffic modeling and is used to predict tailbacks.

The arrangement according to the first exemplary embodiment is used in the third exemplary embodiment (see also FIG. 1).

The third exemplary embodiment differs, however, in each case from the first exemplary embodiment and the second exemplary embodiment in that the variable t originally employed as a time variable is in this case employed as a location variable t.

An original description of a state at time t thus in the third exemplary embodiment describes a state at a first location t. The same applies in each case analogously to a state description at a time t−1 or, as the case may be, t+1 or, as the case may be, t+2.

From the analog transfer of the time variability to a location variability, it furthermore ensues that locations t−1, t, t+1, and t+2 are arranged consecutively along a travel route in a pre-defined direction of travel.

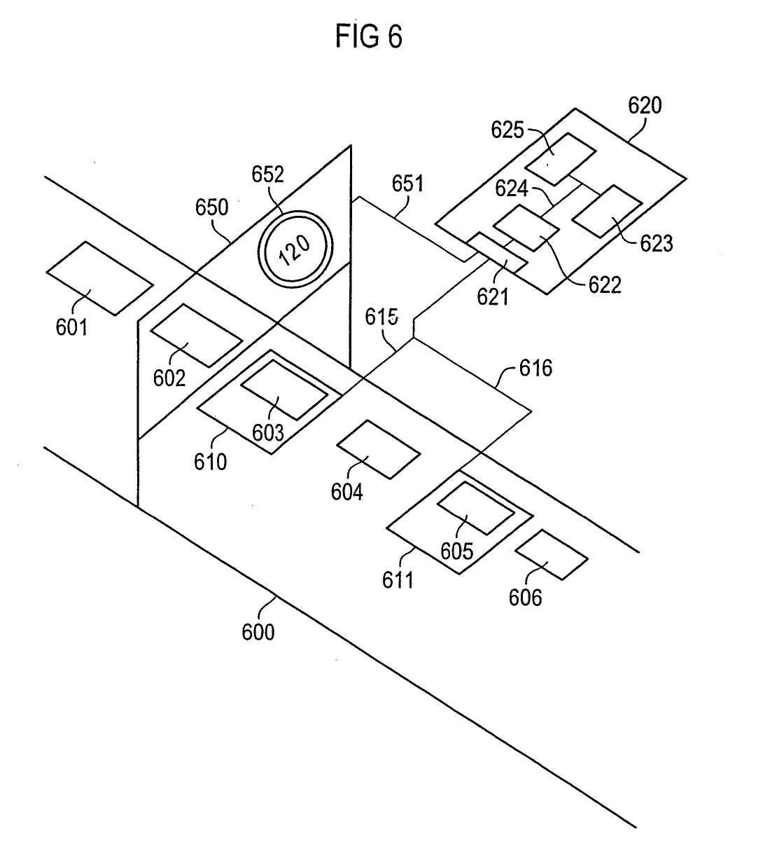

FIG. 6 shows a road 600 along which automobiles 601, 602, 603, 604, 605, and 606 are driving.

Conductor loops 610, 611 integrated in road 600 register electrical signals in a known manner and route the electrical signals 615, 616 to a computer 620 via an input/output interface 621. The electrical signals are digitized into a temporal sequence in an analog/digital converted 622, which is linked to input/output interface 621, and stored in a memory 623 connected via a bus 624 to analog/digital converter 622 and to a processor 625. Control signals 951 from which a pre-defined specified speed 652 can be set in a traffic control system 650, or other details of traffic regulations which are displayed to drivers of the vehicles 601, 602, 603, 604, 605, and 606 via the traffic control system 650, are routed to the traffic control system 650 via input/output interface 621.

The following local state variables are used in this case for traffic modeling:

Speed of traffic flow v,

Vehicle density p

$$( ρ = number of vehicles per kilometer \frac{Fz}{km} )$$

Traffic flow q

$$( q = number of vehicles per hour \frac{Fz}{h} , ( q = v * p ) ) ,$$

(q=v*p)), and

Speed restrictions 952 displayed at one time in each case by traffic control system 950.

The local state variables are measured as described above using conductor loops 610, 611.

These variables (v(t), p(t), q(t)) thus represent a state of the technical “traffic” system at a specific time t. From the variables an assessment r(t) takes place of, in each case, a current state in terms of traffic flow and homogeneity, for instance. The assessment can be on either a quantitative or a qualitative basis.

The traffic dynamic is modeled in two phases within the framework of this exemplary embodiment:

From prediction variables determined during the application phase, control signals 651 are formed by which it is indicated which speed restriction should be selected for a future time period (t+1).

Alternatives to the exemplary embodiments

Some alternatives to the above described exemplary embodiments are presented below.

Alternative areas of application:

The arrangement described in the first exemplary embodiment can also be used to determine a dynamic characteristic of an electrocardiogram (ECG). This will facilitate the early detection of indicators pointing to an increased risk of heart attack. A temporal sequence comprising ECG values measured on a patient is used as an input variable.

In a further alternative to the first exemplary embodiment an arrangement according to the first exemplary embodiment is used for an instance of traffic modeling according to the third exemplary embodiment.

The variable t originally used (in the first exemplary embodiment) as a time variable is in this case used, as described within the framework of the third exemplary embodiment, as a location variable t.

The explanations about this given for the third exemplary embodiment apply analogously.

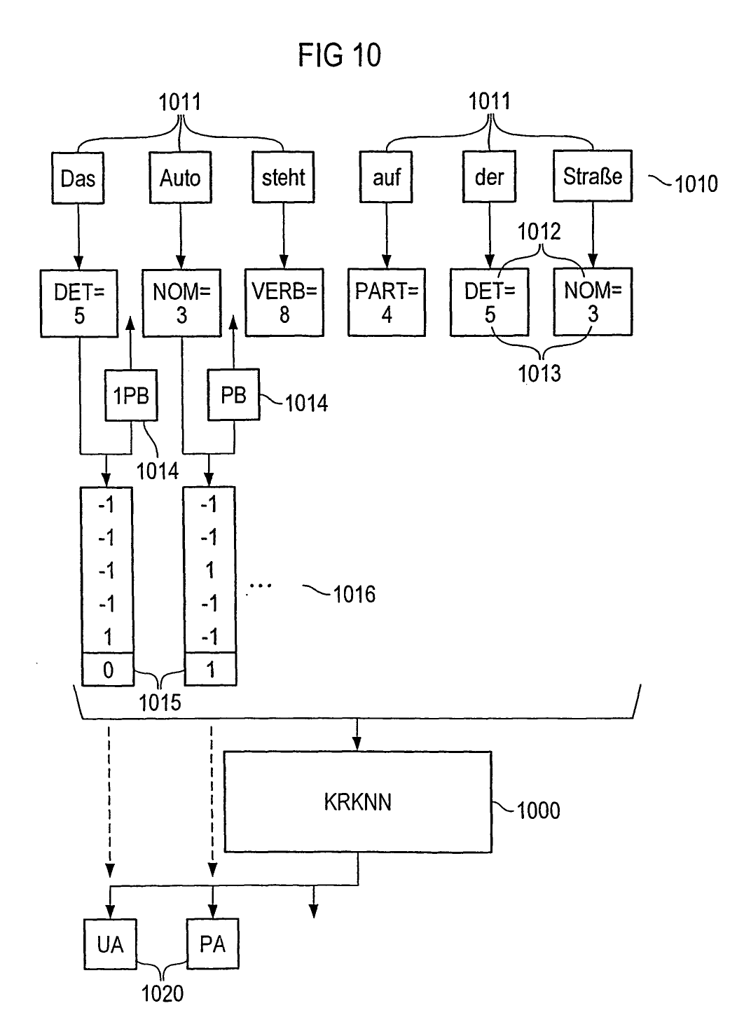

In a third alternative to the first exemplary embodiment the arrangement according to the first exemplary embodiment is used within the framework of speech processing (FIG. 10). Basic principles of speech processing of this type are known from J. Hirschberg, Pitch accent in context: predicting intonational prominence from text, Artificial Intelligence 63, pp. 305-340, Elsevier, 1993 (“the Hirschberg reference”).

The arrangement (KRKNN) 1000 is employed in this case in order to determine the articulation in a sentence 1010 being articulated.

For this, the sentence 1010 being articulated is broken down into its component words 1011 and these are each classified 1012 (part-of-speech tagging). The classifications 1012 are each coded 1013. Each code 1013 is extended to include pause information 1014 (phrase-break information) in each case indicating whether a pause is made after the respective word when sentence 1010 being articulated is spoken.

This type of coding of a sentence being articulated is known from the Hirschberg reference and K. Ross et al., Prediction of abstract prosodic labels for speech synthesis, Computer Speech and Language, 10, pp. 155-185,1996 (“the Ross et al. reference”).

A temporal sequence 1016 is formed from the extended codes 1015 of the sentence in such a way that a temporal sequence of states of the temporal sequence corresponds to the succession of words in the sentence 1010 being articulated. The temporal sequence 1016 is applied to arrangement 1000.

For each word 1011 the arrangement then determines articulation information 1020 (HA: main stress or, as the case may be, strongly articulated; NA: secondary stress or, as the case may be, weakly articulated; KA: no stress or, as the case may be, not articulated) indicating whether the relevant word is spoken with an articulation.

The explanations about this given for the first exemplary embodiment apply analogously.

The arrangement described in the second exemplary embodiment can also be used in an alternative embodiment to predict a macroeconomic dynamic characteristic, for example the course of an exchange rate, or other economic parameters including, for instance, those of a stock exchange quotation. With a prediction of this type an input variable is formed from temporal sequences of relevant macroeconomic or, as the case may be, economic parameters such as interest rates, currencies or inflation rates.

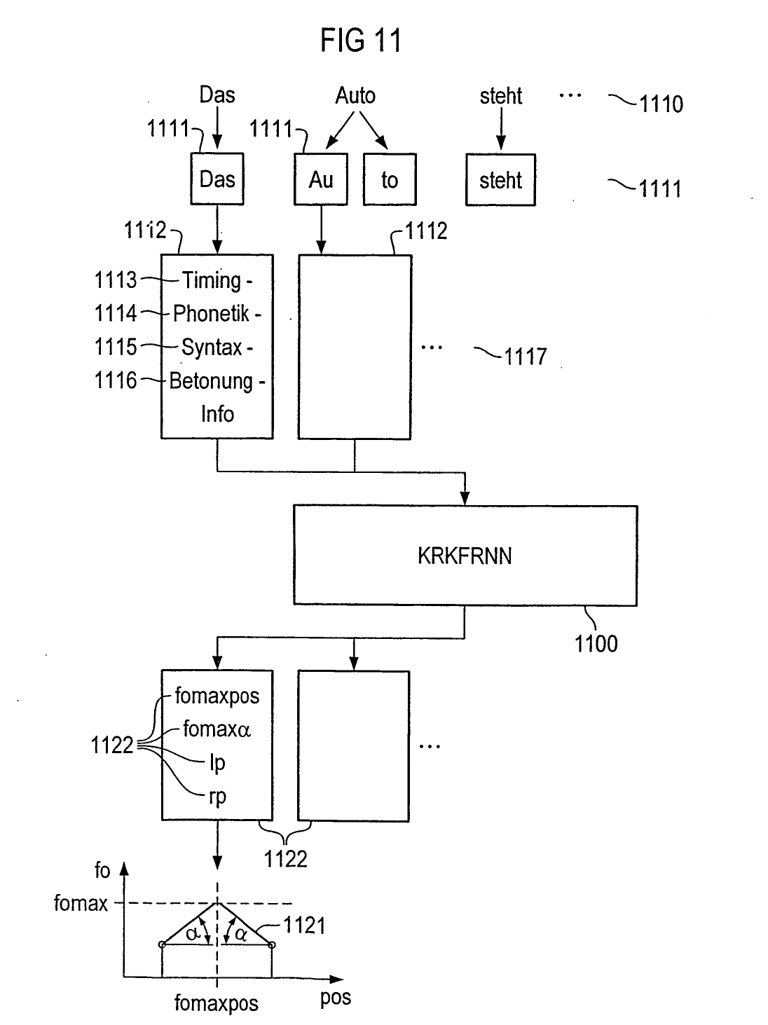

In a further alternative to the second exemplary embodiment the arrangement according to the second exemplary embodiment is employed within the framework of speech processing (FIG. 11). Basic principles of speech processing of this type are known from R. Haury et al., Optimisation of a Neural Network for Pitch Contour Generation, ICASSP, Seattle, 1998 (“the Haury et al. reference”), C. Traber, FO generation with a database of natural FO patterns and with a neural network, G. Bailly and C. Benoit eds., Talking Machines: Theories, Models and Applications, Elsevier, 1992 (“the Traber reference”), E. Heuft et al., Parametric Description of FO-Contours in a Prosodic Database, Proc. ICPHS, Vol. 2, pp. 378-381, 1995 (“the Heuft et al. reference”), and C. Erdem, Topologieoptimierung eines Neuronalen Netzes zur Generierung von FO-Verlaeufen durch Integration unterschiedlicher Codierungen, Tagungsband ESSV, Cottbus, 2000 (“the Erdem reference”).

In this case, namely of syllable-based speech processing, arrangement (KRKFKNN) 1100 is employed for modeling the frequency contour of a syllable of a word in a sentence.

Modeling of this type is also known from the Haury et al. reference, the Traber reference, the Heuft et al. reference, and the Erdem reference.

For this, the sentence 1110 being modeled is broken down into syllables 1111. For each syllable a state vector 1112 is determined which describes the syllable phonetically and structurally.

A state vector 1112 of this type contains timing information 1113, phonetic information 1114, syntax information 1115, and stress information 1116.

A state vector 1112 of this type is described in the Ross et al. reference.

A temporal sequence 1117 is formed from state vectors 1112 of syllables 1111 of the sentence being modeled in such a way that a temporal sequence of states of the temporal sequence 1117 corresponds to the succession of syllables 1111 in the sentence 1110 being modeled. The temporal sequence 1117 is applied to arrangement 1100.

Arrangement 1100 then determines for each syllable 1111 a parameter vector 1122 with parameters 1120, fomaxpos, fomaxalpha, lp, rp, describing frequency contour 1121 of the respective syllable 1111.

Parameters 1120 of this type and the description of a frequency contour 1121 by the parameters 1120 are known from the Haury et al. reference, the Traber reference, the Heuft et al. reference, and the Erdem reference.

The explanations about this given for the second exemplary embodiment apply analogously.

Structural Alternatives

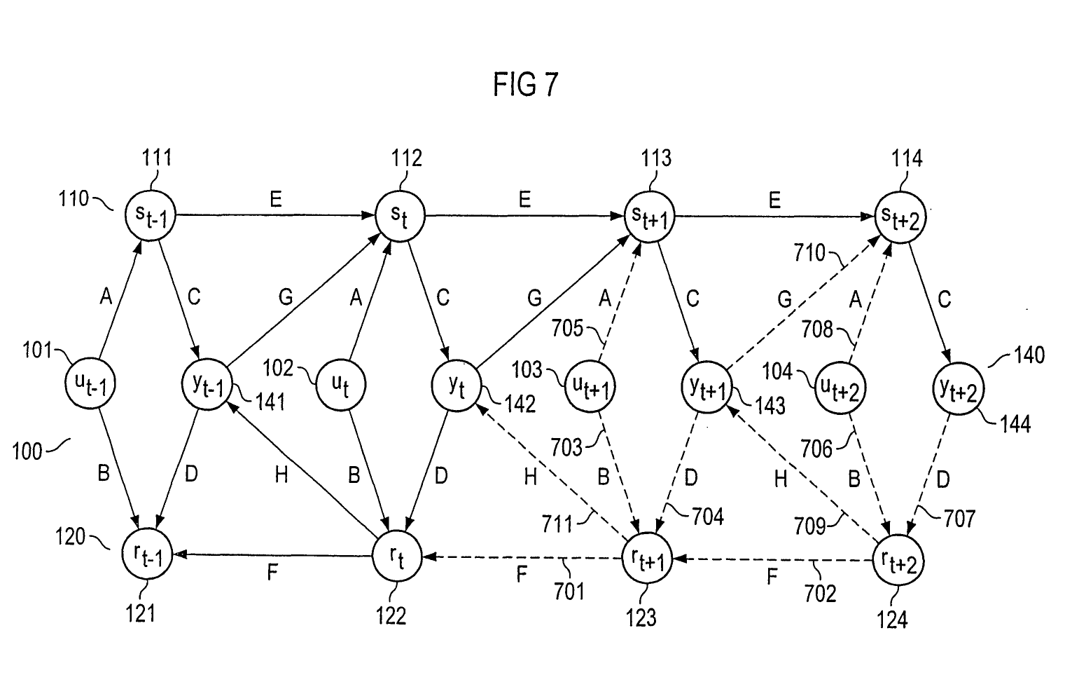

FIG. 7 shows a structural alternative to the arrangement from FIG. 1 according to the first exemplary embodiment.

Components from FIG. 1 are given the same reference numerals in FIG. 7 where the embodiment is the same.

In contrast to the arrangement shown in FIG. 1, in the alternative arrangement according to FIG. 7 connections 701, 702, 703, 704, 705, 706, 707, 708, 709, 710, and 711 have been released or, as the case may be, interrupted.

The alternative arrangement, namely a KRKNN with released connections, can be used in both a training phase an application phase.

The alternative arrangement is trained and applied in a manner analogous to that described for the first exemplary embodiment described.

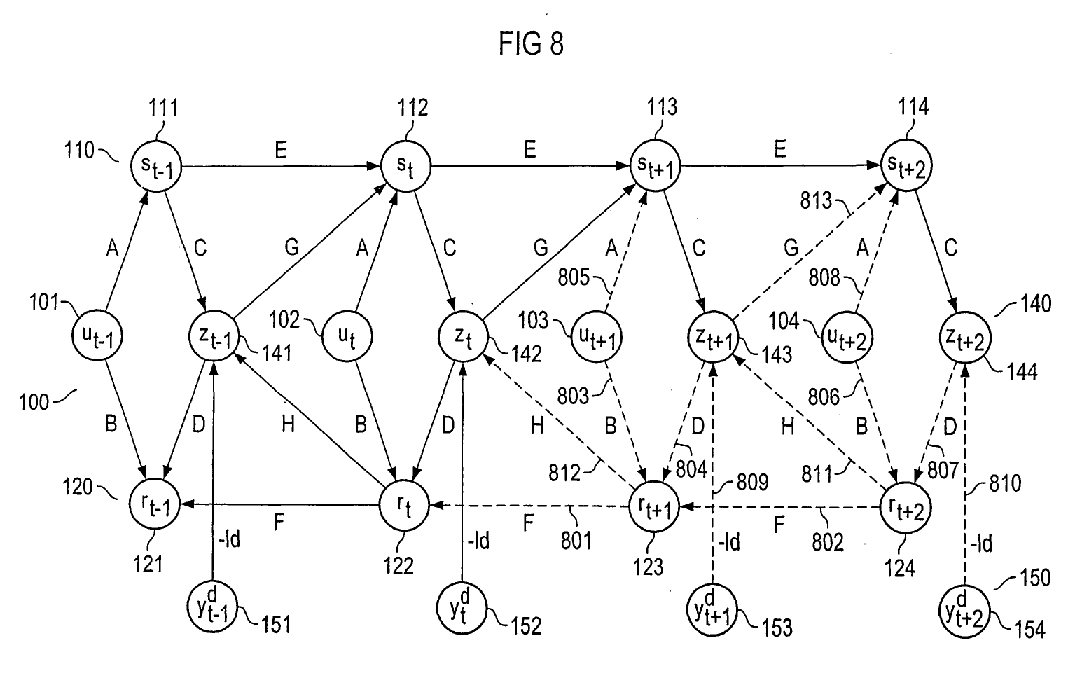

FIG. 8 shows a structural alternative to the arrangement from FIG. 3 according to the second exemplary embodiment.

Components from FIG. 3 are given the same reference numerals in FIG. 8 where the embodiment is the same.

In contrast to the arrangement shown in FIG. 3, in the alternative arrangement according to FIG. 8 connections 801, 802, 803, 804, 805, 806, 807, 808, 809, 810, 811, 812, and 813 have been released or, as the case may be, interrupted.

The alternative arrangement, namely a KRKFKNN with released connections, can be used in both a training phase an application phase.

The alternative arrangement is trained and applied in a manner analogous to that described for the second exemplary embodiment described.

It must be noted that it is possible to use the KRKNN with released connections only in the training phase and the KRKNN (without the released connections according to the first exemplary embodiment) in the application phase.

It is also possible to use the KRKNN with released connections only in the application phase and the KRKNN (without the released connections according to the first exemplary embodiment) in the training phase.

The same applies analogously to the KRKFKNN and the KRKFKNN with released connections.

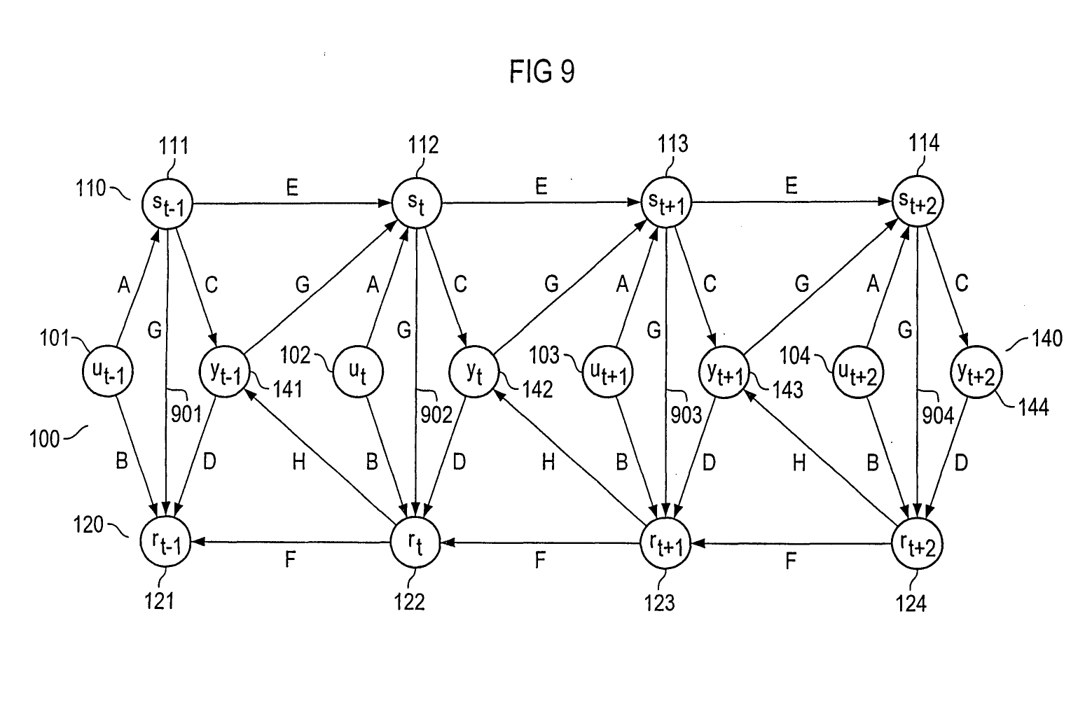

A further structural alternative to the arrangement according to the first exemplary embodiment is shown in FIG. 9.

The arrangement according to FIG. 9 is a KRKNN with fixed-point recurrence.

Components from FIG. 1 are given the same reference numerals in FIG. 8 where the embodiment is the same.

In contrast to the arrangement shown in FIG. 1, in the alternative arrangement according to FIG. 9 additional connections 901, 902, 903, and 904 are closed.

Additional connections 901, 902, 903, and 904 each have a connection matrix GT with weights.

The alternative arrangement can be used in both a training phase and an application phase.

The alternative arrangement is trained and applied in a manner analogous to that described for the first exemplary embodiment.

The invention has been described in detail with particular reference to preferred embodiments thereof and examples, but it will be understood that variations and modifications can be effected within the spirit and scope of the invention.

1-22. (cancelled)

23. A method for determining a current first state of a first temporal sequence of respective first states of a dynamically modifiable system in a first state space, comprising:
determining a second temporal sequence of respective second states of the system in a second state space, the second temporal sequence having a current second state and an older second state temporally preceding the current second state;
determining a third temporal sequence of respective third states of the system in the second state space, the third temporal sequence having a future third state and a younger third state temporally succeeding the future third state; and
determining the current first state by transforming the current second state from the second state space to the first state space and by transforming the future third state from the second state space to a future state space.

24. The method according to claim 23,
wherein two temporally succeeding second states of the second temporal sequence are coupled to each other by a transformation.

25. The method according to claim 24,
wherein two temporally succeeding second states of the second temporal sequence are coupled to each other by the transformation in such a way that a temporally younger second state is determined from a temporally older second state.

26. The method according to claim 23,
wherein two temporally succeeding third states of the third temporal sequence are coupled to each other by a transformation.

27. The method according to claim 26,
wherein two temporally succeeding third states of the third temporal sequence are coupled to each other by a transformation in which a temporally older third state is formed from a temporally younger third state.

28. The method according to claim 25, wherein the younger second state of the second temporal sequence, temporally succeeding the current second state, is determined
by transforming the current second state to the younger second state, and
by transforming the current state from the first state space to the second state space.

29. The method according to claim 27, wherein a current third state of the third temporal sequence, temporally preceding the future third state, is determined
by transforming the current third state from the future third state, and
by transforming the current state from the first state space to the second state space.

30. The method according to claim 23,
further comprising determining an error between the current first state and a pre-defined first state.

31. The method according to claim 23,
wherein external state information of the system is in each case routed to the second states of the second temporal sequence and/or to the third states of the third temporal sequence.

32. The method according to claim 23,
wherein the states of the system are described by vectors of pre-definable dimension.

33. The method according to claim 23,
wherein the first temporal sequence of the respective first states is used to describe a dynamic characteristic of the system.

34. The method according to claim 33, wherein
the first temporal sequence of the respective first states corresponds to a temporal sequence of signals of an electrocardiogram, and
the first temporal sequence is used to analyze the electrocardiogram.

35. The method according to claim 33, wherein
the first states are economic states, and
the first states are described by an economic variable.

36. The method according to claim 33, wherein
the first temporal sequence of the respective first states corresponds to a sequence of values for chemical properties in a chemical reactor.

37. The method according to claim 23,
wherein the current first state is a predicated state.

38. The method according to claim 25,
wherein two temporally succeeding third states of the third temporal sequence are coupled to each other by a transformation in which a temporally older third state is formed from a temporally younger third state.

39. The method according to claim 38, wherein the younger second state of the second temporal sequence, temporally succeeding the current second state, is determined
by transforming the current second state to the younger second state, and
by transforming the current state from the first state space to the second state space.

40. The method according to claim 39, wherein a current third state of the third temporal sequence, temporally preceding the future third state, is determined
by transforming the current third state from the future third state, and
by transforming the current state from the first state space to the second state space.

41. The method according to claim 40,
further comprising determining an error between the current first state and a pre-defined first state.

42. The method according to claim 41,
wherein external state information of the system is in each case routed to the second states of the second temporal sequence and/or to the third states of the third temporal sequence.

43. The method according to claim 42,
wherein the states of the system are described by vectors of pre-definable dimension.

44. The method according to claim 43,
wherein the first temporal sequence of the respective first states is used to describe a dynamic characteristic of the system.

45. The method according to claim 44, wherein
the first temporal sequence of the respective first states corresponds to a temporal sequence of signals of an electrocardiogram, and
the first temporal sequence is used to analyze the electrocardiogram.

46. The method according to claim 44, wherein
the first states are economic states, and
the first states are described by an economic variable.

47. The method according to claim 44, wherein
the first temporal sequence of the respective first states corresponds to a sequence of values for chemical properties in a chemical reactor.

48. The method according to claim 44,
wherein the current first state is a predicated state.

49. An apparatus to determine a current first state of a first temporal sequence of respective first states of a dynamically modifiable system in a first state space with interlinked computing elements, the computing elements in each case representing a state of the system, the links in each case representing a transformation between two states of the system, comprising:
first computing elements to determine a second temporal sequence of respective second states of the system in a second state space, the second temporal sequence having a current second state and an older second state temporally preceding the current second state;
second computing elements to determine a third temporal sequence of respective third states of the system in the second state space, the third temporal sequence having a future third state and a younger third state temporally succeeding the future third state;
a third computing element to determine the current first state by transforming the current second state from the second state space to the first state space and by transforming the future third state from the second state space to a future state space.

50. The apparatus according to claim 49, wherein
the apparatus further comprises fourth computing elements which are in each case linked to a first computing element and/or to a second computing element,
a fourth state of a fourth temporal sequence of respective fourth states of the system is routed to one of the fourth computing elements, and
each fourth state contains external state information of the system.

51. The apparatus according to claim 49, wherein
at least a part of the computing elements are artificial neurons and/or
at least a part of the links between the computing elements are embodied on a variable basis.

52. The apparatus according to claim 49, wherein
the apparatus further comprises a measuring unit to record physical signals, and
the states of the dynamically modifiable system describe the physical signals.

53. The apparatus according to claim 50, wherein
the external state information is a first item of speech information of a word and/or syllable and/or a phoneme being spoken, and
the current first state comprises a second item of speech information of the word and/or syllable and/or the phoneme being spoken.

54. The apparatus according to claim 53, wherein
the first item of speech information includes classification and/or pause information for the word and/or syllable and/or phoneme being spoken, and
the second item of speech information includes articulation and/or sound length information for the word and/or syllable and/or phoneme being spoken.

55. The apparatus according to claim 54, wherein
the first item of speech information includes phonetic and/or structural information about the word and/or syllable and/or phoneme being spoken, and
the second item of speech information includes frequency and/or sound duration information about the word and/or syllable and/or phoneme being spoken.

56. The apparatus according to claim 50, wherein
at least a part of the computing elements are artificial neurons and/or
at least a part of the links between the computing elements are embodied on a variable basis.

57. The apparatus according to claim 56, wherein
the apparatus further comprises a measuring unit to record physical signals, and
the states of the dynamically modifiable system describe the physical signals.

58. The apparatus according to claim 56, wherein
the external state information is a first item of speech information of a word and/or syllable and/or a phoneme being spoken, and
the current first state comprises a second item of speech information of the word and/or syllable and/or the phoneme being spoken.

59. The apparatus according to claim 58, wherein
the first item of speech information includes classification and/or pause information for the word and/or syllable and/or phoneme being spoken, and
the second item of speech information includes articulation and/or sound length information for the word and/or syllable and/or phoneme being spoken.

60. The apparatus according to claim 59, wherein
the first item of speech information includes phonetic and/or structural information about the word and/or syllable and/or phoneme being spoken, and
the second item of speech information includes frequency and/or sound duration information about the word and/or syllable and/or phoneme being spoken.
